(19) United States
(12) Patent Application Publication
(10) Pub. No.: US 2023/0189755 A1
(43) Pub. Date: Jun. 22, 2023

(54) WILDLIFE FEEDER

(71) Applicant: AOB Products Company, Columbia, MO (US)

(72) Inventors: Todd Strobel, Columbia, MO (US); Aaron Wood, Columbia, MO (US); Ryan Varnum, Columbia, MO (US); Seth Wheeler, Columbia, MO (US); Justin Murphy, Columbia, MO (US); Matthew Kinamore, Columbia, MO (US); Timothy S. Kinney, Warrenton, MO (US); James Tayon, Moberly, MO (US)

(73) Assignee: AOB Products Company, Columbia, MO (US)

(21) Appl. No.: 18/085,543

(22) Filed: Dec. 20, 2022

Related U.S. Application Data
(60) Provisional application No. 63/265,736, filed on Dec. 20, 2021.

(51) Int. Cl. A01K 5/02

(52) U.S. Cl. CPC A01K 5/0225

(57) ABSTRACT

A ground level gravity wildlife feeder assembly, components thereof, and associated methods. The wildlife feeder comprises a base assembly including a base, a feed director, and a plurality of selectively moveable gates configured to permit or restrict feed from exiting the base. The wildlife feeder comprises a hopper assembly configured to hold a supply of feed material and is supportably connected to the base.

### CROSS REFERENCE TO RELATED APPLICATION

The present application claims priority to U.S. Provisional Pat. App. No. 63/265,736 filed Dec. 20, 2021, which is hereby incorporated by reference in its entirety.

### FIELD

The present disclosure generally relates to animal feeders, and more particularly to game feeders.

### BACKGROUND

Wildlife feeders are designed to hold relatively large volumes of bulk feed material. As such, wildlife feeders tend to occupy unnecessary space, for example, during packaging, sale, or storage.

### SUMMARY

In one aspect, a wildlife gravity feeder assembly for dispensing a bulk feed material comprises a hopper body which defines an interior for holding the bulk feed material. A base assembly comprises a base which defines at least one feed outlet. A feed director body is formed separately from the base and is supported by the base. The feed director body defines at least one funnel configured to direct bulk feed material to flow by gravity from the interior toward the at least one feed outlet.

In another aspect, a wildlife gravity feeder assembly for dispensing a supply of bulk feed material comprises a base and a hopper body. The hopper body is configured to be connected to the base to define an interior for holding a supply of bulk feed material. A hopper body has at least two sidewall portions that are formed separately and connectable to each other for forming the hopper body.

In yet another aspect, a wildlife gravity feeder assembly for dispensing bulk feed material comprises a base and a hopper body. The hopper body defines an interior for holding the bulk feed material. The hopper body is connectable to the base. The base is configured to form a bottom of the interior.

In yet another aspect, a wildlife gravity feeder assembly is for dispensing bulk feed material. The assembly includes a hopper body including an inlet opening and at least two feed openings located below the inlet opening. At least two funnels are located in an interior space of the hopper body below the inlet opening. Each funnel corresponds to a respective feed opening. Each funnel includes a feed channel including a slide surface extending downwardly toward the respective feed opening. A width of each channel widens toward the respective feed opening.

Other objects and features of the present disclosure will be in part apparent and in part pointed out herein.

### BRIEF DESCRIPTION OF THE DRAWINGS

FIG. 1 is a perspective of a ground level gravity feeder;

FIG. 2 is an exploded view of the ground level gravity feeder including a base assembly and a hopper assembly;

FIG. 3 is a perspective of a base;

FIG. 4 is a section of the base;

FIG. 5 is a perspective of a first embodiment of a feed director;

FIG. 6 is a perspective of the base assembly;

FIG. 7 is a section view of FIG. 6;

FIG. 7A is a section view of a second embodiment of a feed director held in the base;

FIG. 8 is a perspective of a second embodiment of a feed director;

FIG. 9 a perspective of the base assembly including the second embodiment of the feed director;

FIG. 10 is a perspective of an interior side of a sidewall of the hopper assembly;

FIG. 11 is a perspective of an exterior side of the sidewall of FIG. 10;

FIG. 12 is a perspective of an interlocking connection of two sidewalls;

FIG. 13 is a perspective of FIG. 12 mounted to the base assembly;

FIG. 14 is similar to FIG. 13 including a third sidewall; and

FIG. 15 is similar to FIG. 14 including a fourth sidewall.

Corresponding reference numbers indicate corresponding parts throughout the drawings.

### DETAILED DESCRIPTION

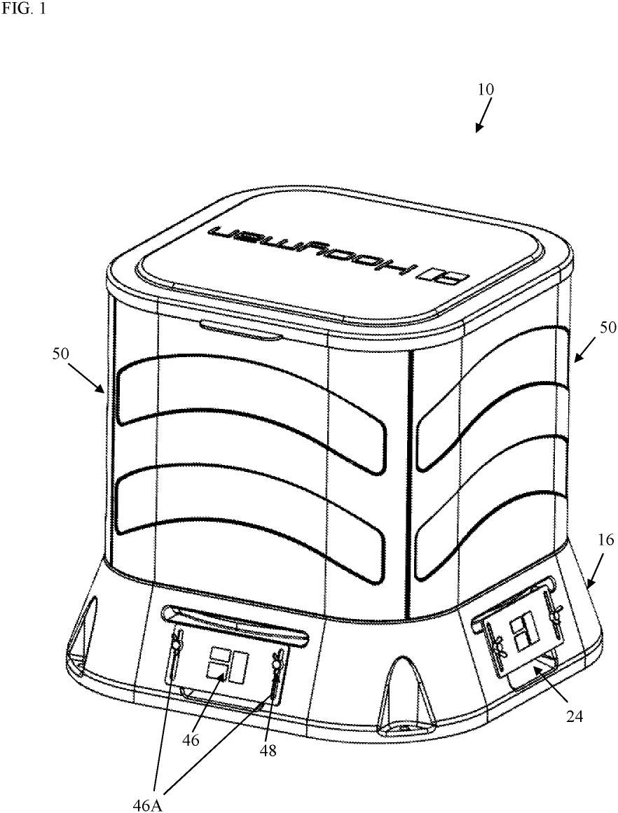

Referring to FIG. 1, a ground level gravity feeder (broadly, “gravity feeder” or “feeder”) of the present disclosure is indicated by 10. The gravity feeder may be filled with a supply of bulk feed material (e.g. corn, grain, beans, etc.) and placed on a ground surface (broadly, “support surface”) (e.g. forest floor, tree stump, cinder block, etc.). The feeder is configured to dispense feed near the bottom of the feeder and onto the surrounding ground area to allow game/wildlife (e.g. deer, hogs, turkeys, etc.) to eat the feed material from the ground and/or feed outlet 24. It will be appreciated that aspects of the current disclosure can be incorporated in other types of feeders without departing from the scope of the present disclosure.

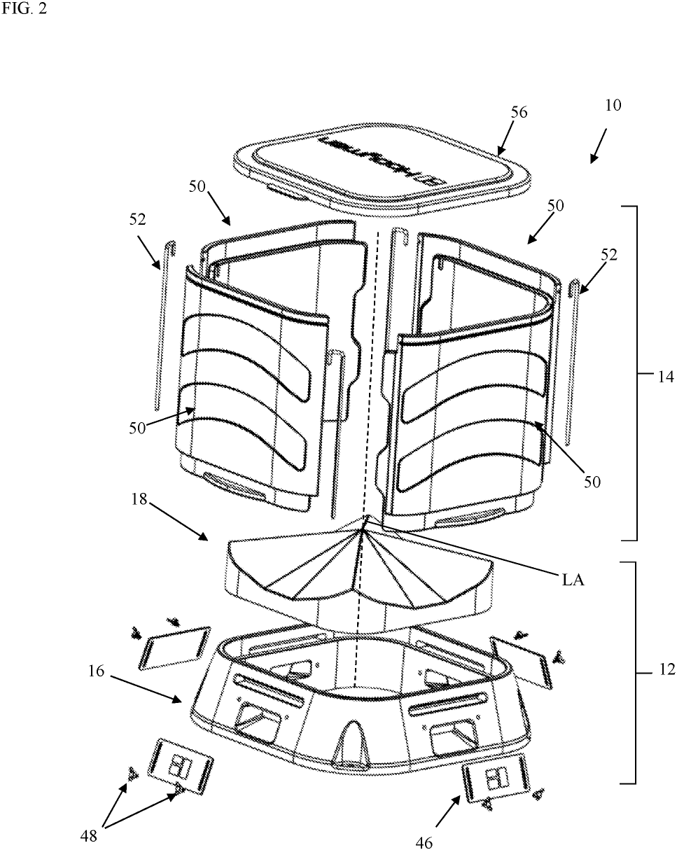

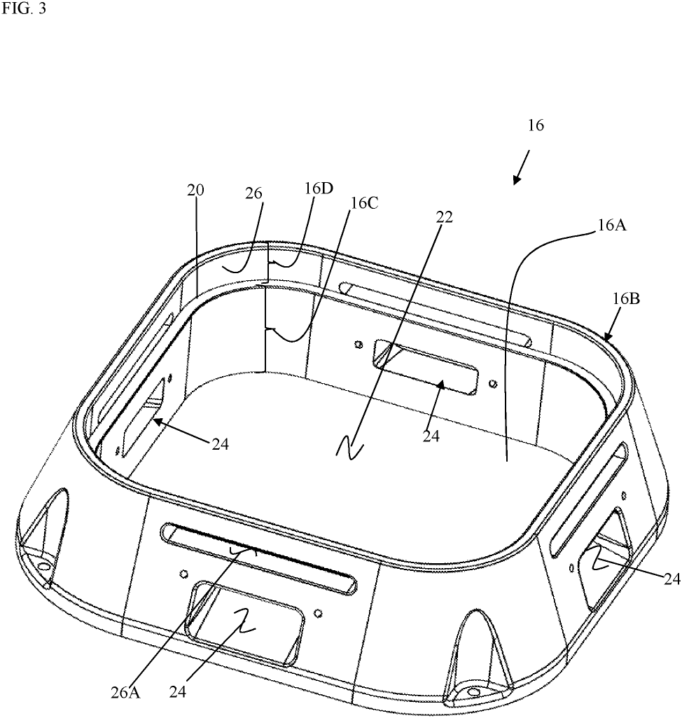

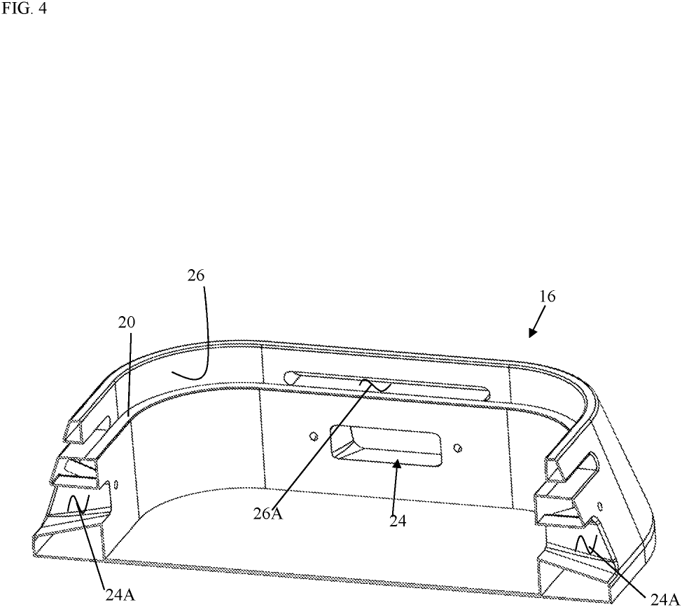

Referring to FIGS. 2-4, the gravity feeder 10 comprises a base assembly 12 and a hopper assembly 14. The base assembly includes a base 16 and a feed director 18. The base 16 is generally square and includes linear edge portions and arcuate edge portions forming corners between the linear edge portions. A floor 16A of the base has an interior sized and shaped to correspond with the size and shape of the feed director 18. An exterior side of the base (broadly, “footprint”) is configured to engage the ground surface. The base is generally square having linear edge portions and rounded (broadly, “arcuate”) edge portions or corners. A continuous wall 16B having four sides extends upward from a periphery of the base. The continuous wall 16B includes a lower portion 16C and an upper portion 16D. A shoulder 20 separates the lower portion from the upper portion and is configured to engage a sidewall portion of the hopper, as will be explained below. FIG. 4 illustrates the width of the continuous sidewall being wider towards the base of the lower portion and gradually narrowing toward the upper portion. An interior of the sidewall is upstanding with respect to the base (i.e. about ninety-degrees with respect to the base) whereas an exterior side of the sidewall is angled inward relative to the interior side. Exterior corners of the base define through-holes (broadly, “mounts”) configured to receive a stake for securing the feeder to the ground.

The lower portion 16C spans from the floor 16A to the shoulder 20. A cavity 22 is defined by the base and is sized and shaped for receiving the feed director. The lower portion 16C defines a feed outlet 24 which passes through the width of the lower portion 16C. In the illustrated embodiment, there are four feed outlets 24. Each feed outlet 24 defines a feed passage 24A including a passage axis CA. In the illustrated embodiment, the passage axis CA is angled generally toward the ground. In the illustrated embodiment, the feed outlets are arranged on each side of the generally square base so that feed will exit from four sides of the feeder.

The upper portion 16D of the continuous wall is configured to support each sidewall of the hopper assembly and can be referred to broadly as sidewall connection structure. The sidewall connection structure includes the shoulder 20 and a collar 26. The height of the collar is sufficient to define a recess 26A (broadly, “sidewall connector”) and to overlap a bottom portion of the sidewall to provide support and rigidity, as will be described in greater detail below. In the illustrated embodiment, there is a recess including an elongate slot arranged generally above each of the four feed outlets.

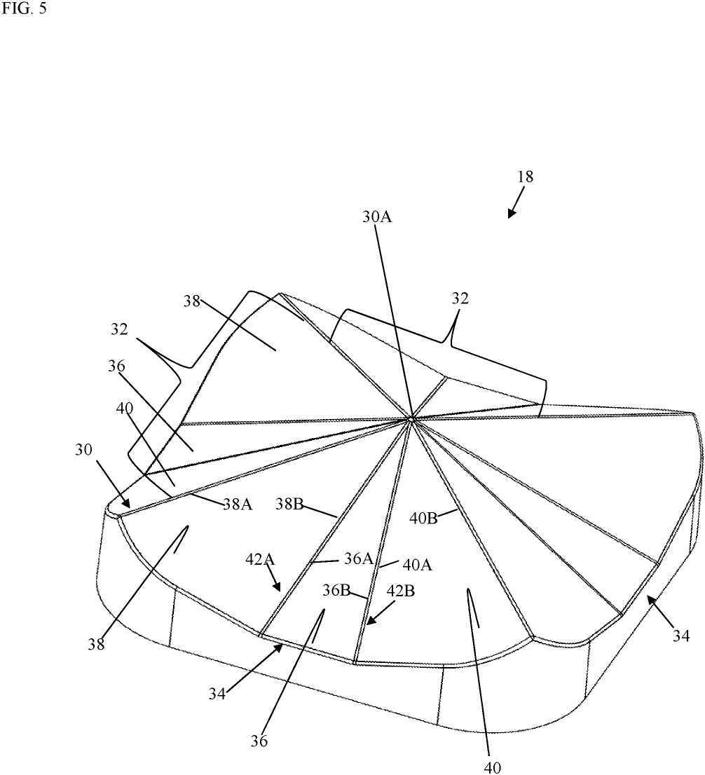

Referring to FIG. 5, the feed director 18 includes a generally square feed director body having linear edge portions and rounded (broadly, “arcuate”) edge portions, or corners, to correspond with the base cavity 22. The feed director 18 has a bottom side, a top side opposite the bottom side, and varying thickness therebetween. The bottom side is flat to correspond with the floor 16A of the base. A spine 30 having four crests, generally referred to as an X-shaped spine, is arranged on the top side of the feed director body. A longitudinal axis LA extends through the intersection. The X-shaped spine divides the director body into four funnels 32. A peak 30A is formed at the intersection of the X-shaped spine and defines a highest point of the feed director to further facilitate in directing feed equally toward the funnels. The configuration is such that each funnel 32 shares a point in common at the peak 30A. Each funnel 32 extends downwardly from the peak 30A toward a respective side of the square body. Other spine configurations (e.g. Y- shape) are not outside the scope of this disclosure.

Referring to FIG. 5, the funnel facing generally out of the page will be described in greater detail with the understanding each of the four funnels is substantially identical. In the illustrated embodiment, the funnel 32 comprises a contoured surface and a mouth 34. The contoured surface includes a center (first) face 36, a left (second) face 38, and a right (third) face 40. In the illustrated embodiment, each face is generally triangular and sharing a point in common at the peak 30A.

The center face 36 extends downward toward the mouth. The left face 38 and the right face 40 slope toward the center face 36. The left face 38 includes a left (first) edge 38A and a right (second) edge 38B. The center face 36 includes a left (first) edge 36A and a right (second) edge 36B. The right face 40 includes a left (first) edge 40A and a right (second) edge 40B. The left edge of the left face defines one of the crests of the spine. Similarly, the right edge of the right face forms another crest of the spine. With respect to the peak 30A, a width between the left edge 38A and the right edge 40B increases or widens in the direction of the mouth 34. The center face 36 forms a slide surface of a feed channel bounded on its sides by the left and right faces 38, 40.

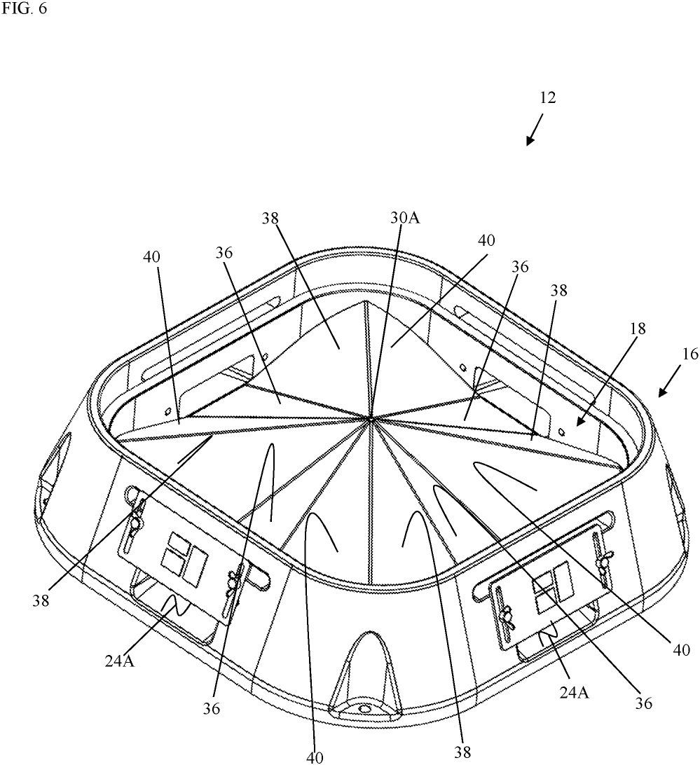

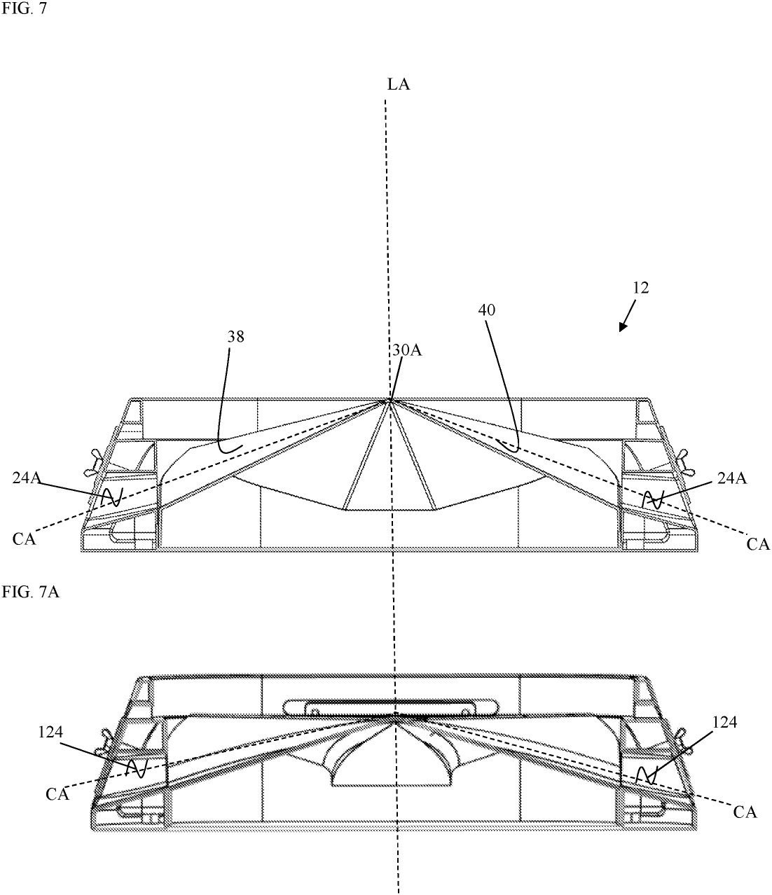

Referring to FIGS. 6 and 7, each funnel 32 is associated with a corresponding feed outlet 24 so the angle of the center face 36 smoothly transitions into the angle of the feed outlet 24. The configuration is such that the channel axis CA of each channel can extend from the longitudinal axis LA intersection at the peak to the ground surface without intersecting any structure other than the feed gate, depending on the positon of the feed gate as set by the user. The arrangement allows gravity to facilitate in funneling feed from the hopper to the ground without stopping or pooling within the base.

Different feed director shapes can be used without departing from the scope of this disclosure. Moreover, an integrally formed base and feed director is not outside the scope of this disclosure.

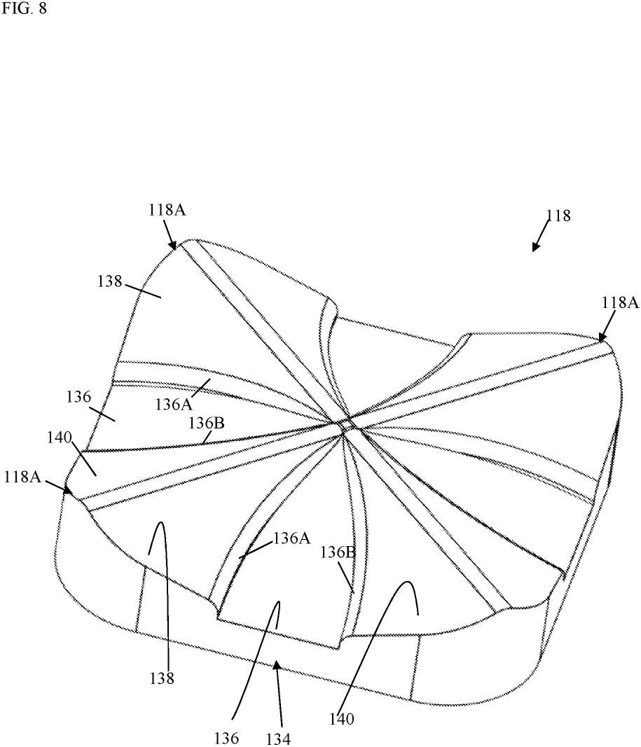

Referring to FIGS. 7A, 8, and 9, a feed director 118 is similar to the feed director 18, and the like components are indicated by like reference numbers plus 100. For example, the feed director 118 includes a generally square feed director body having linear edge portions and rounded (broadly, “arcuate”) edge portions. The feed director 118 has a bottom side, a top side opposite the bottom side, and varying thickness therebetween. The bottom side is flat to correspond with the floor 16A of the base 16. A spine 130 having four crests, generally referred to as an X-shaped spine is arranged on the top side of the feed director body. The X-shaped spine divides the director body into four funnels 132. The configuration is such that each funnel 132 shares a point in common at an intersection of the X-shaped spine. Each funnel 132 extends downwardly from the intersection toward a respective side of the square body.

Each funnel 132 comprises a contoured surface and a widening mouth 134. The contoured surface includes a center (first) face 136, a left (second) face 138, and a right (third) face 140.

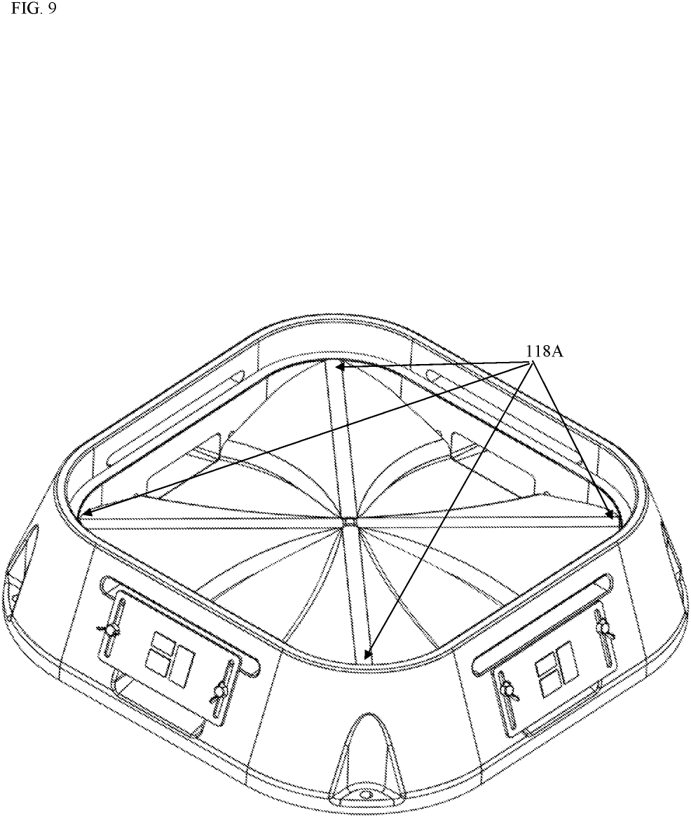

Unlike the feed director 18, pillars 118A are arranged at each of the four corners. Each pillar is bisected by a crest of the X-shaped spine and defines the left face 138 of one funnel and the right face 140 of an adjacent funnel. Moreover, the left and right faces 138, 140 are arranged near the corners of the director body and abut the continuous wall of the base (FIG. 9). A first vane (broadly, “guide”) 136A protrudes upward from the left edge of the center face and meets the left face 138 to assist in funneling the feed toward the mouth. Similarly, a second vane (broadly, “guide”) 136B protrudes upward from the right edge of the center face and meets the right face 140 (or visa-versa) to assist in the funneling the feed toward the mouth. End portions of the first and second guides 136A, 136B further define the mouth 134, which is wider than the mouth 34. The center face 136 provides a slide surface of a feed channel bounded on the left and right sides by the first and second vanes 136A, 136B. The feed channel widens as it extends downward toward the feed outlet.

The configuration of the feed director 118 is such that the channel axis CA of each feed channel can extend from the longitudinal axis LA to the ground surface without intersecting any structure other than the feed gate. Other configurations can be used without departing from the scope of the present disclosure.

Referring to FIGS. 1, 2, and 14, a feed gate 46 having a gate body is arranged to cover and selectively uncover each one of the feed channels 24A. In the illustrated embodiment, the gate body comprises a rectangular piece of metal sized and shaped to overlie the feed outlet. Left and right sides of the gate body define slots 46A sized and shaped to permit a fastener to pass therethrough. The fastener can be threaded into a corresponding threaded opening on each side of the feed outlet. The user can move the gate either up (first direction) or down (second direction) to change the size of the area of the feed outlet which in turn changes the flow area of the exit or outlet window of the feed outlet. A wing nut 48 is used to loosen the fastener to permit the user to move the gate up or down by sliding the gate along the slots and then retightening the nuts to secure the gate in place. It is appreciated the user may independently change the position each one of the four feed gates 46 as the user desires. For example, the user may have two gates fully closed, one fully open, and another partially open, or any combination thereof. Other ways of moving the gate (e.g. pivotable) are not outside the scope of this disclosure.

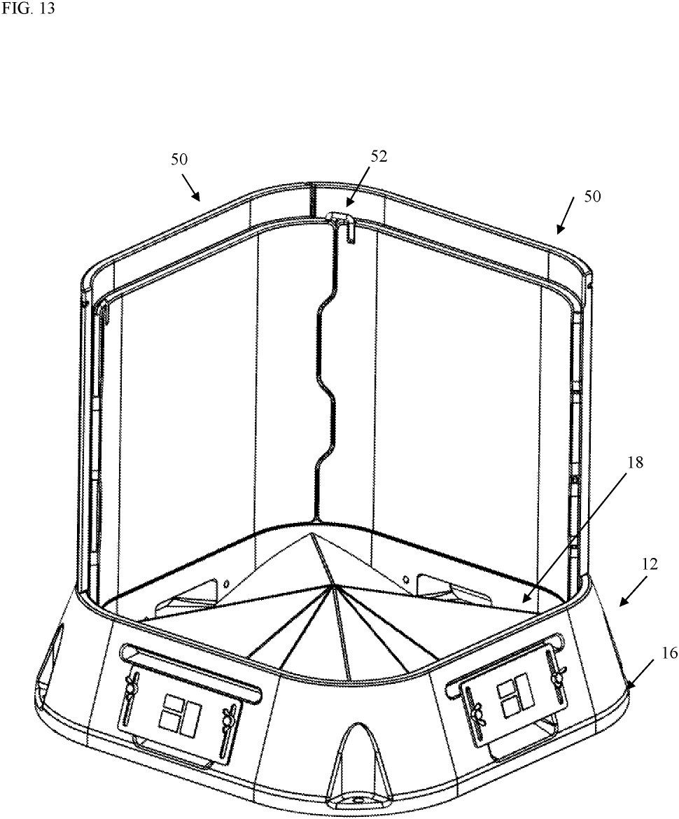

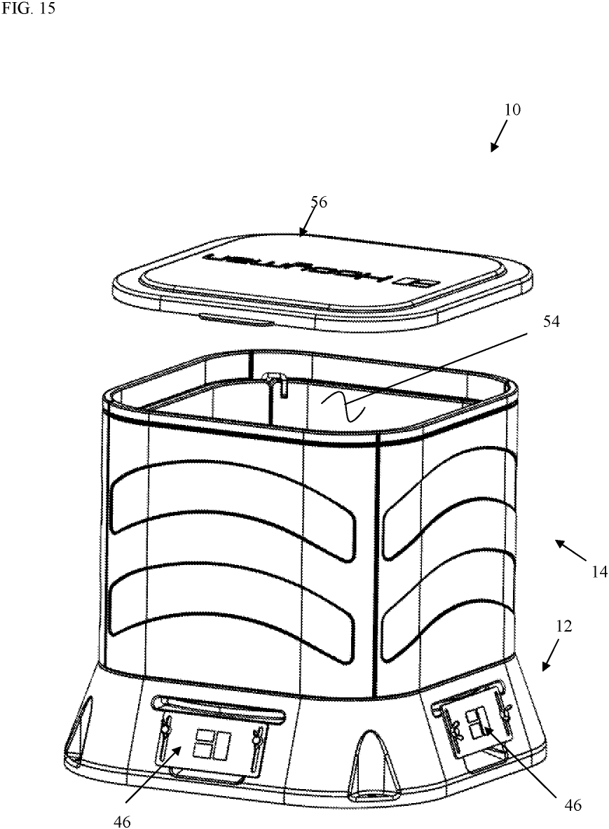

Referring to FIGS. 2 and 10-15, the hopper assembly 14 comprises modular sidewalls (broadly, “hopper portions”) 50 and connecting rods 52. The sidewalls are connectable to each other to configure the sidewalls in an assembled state to form the hopper body The hopper defines an interior and an upper inlet opening 54 through which feed material is dumped to fill the hopper. A lid 56 is usable to cover the opening. When the hopper body is not assembled the sidewalls can stack together in a compact manner, such as to take up less space in retail packaging or storage.

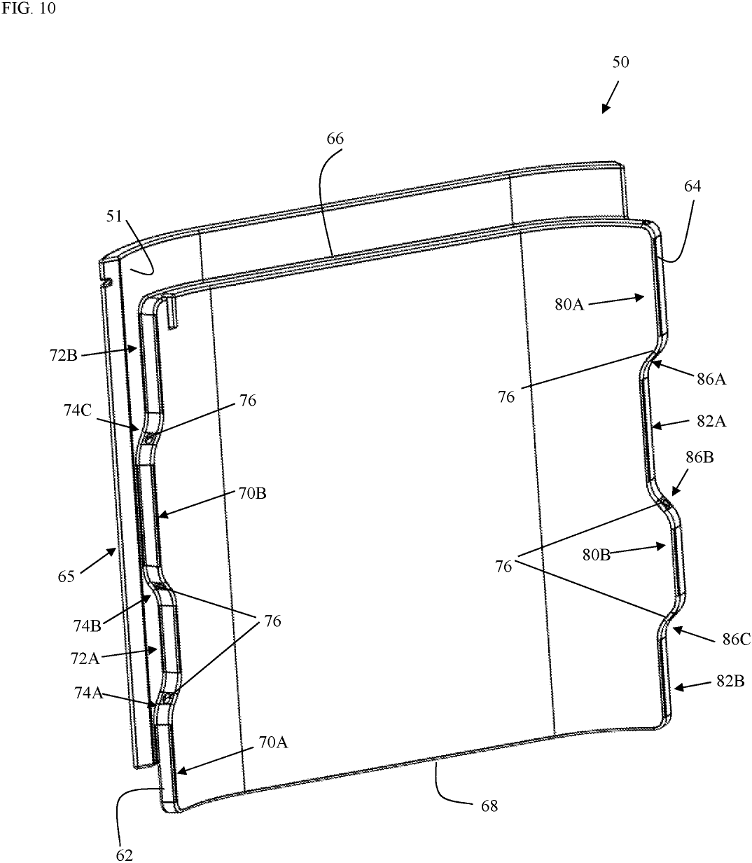

Referring to FIG. 10, one of the sidewalls 50 will be described in greater detail with the understanding each is substantially identical. The sidewall 50 is generally square-shaped having linear and arcuate edge portions. Each sidewall includes an interior face, an exterior face, a left side portion having a left edge 62, right side portion having a right edge 64, a top portion having a top edge 66, and bottom portion having a bottom edge 68. The left and right edges 62, 64 comprise first and second sets of connectors, respectively. The left and right edges 62, 64 are contoured to define projections and recesses which can broadly be referred to as “sidewall connectors.” The left edge 62 includes a web 65 configured to conceal the connection of sidewall connectors form outside the feeder when the hopper body is assembled. The seam between the sidewall connectors is concealed by the web to limit water infiltration. When the sidewalls are connected, a first outer joint (generally linear upstanding joint) is formed and is visible from the exterior, and a second inner joint (e.g., having a serpentine shape) is formed on the interior.

The bottom edge 68 portion is generally flat and configured to engage with the shoulder 20 of the base, as will become apparent. The left edge portion includes a lower projection 70A, a lower recess 72A, an upper projection 70B, and an upper recess 72B (broadly, “first set of connectors”). The lower projection 70A and the bottom edge 68 form a bottom left corner of the sidewall. Starting at the bottom left corner, the lower projection 70A extends in a generally upward direction until the left edge angles inward about forty-five degrees to form a first chamfered edge 74A having a first face. From the first chamfered edge 74A, the left edge continues in an upward direction until it angles outward at about forty-five degrees to form a second chamfered edge 74B having a second face. The first and second faces of the respective first and second chamfered edges generally face each other and further define the lower recess 72A therebetween. From the second chamfered edge 74B, the left edge continues in an upright direction until in angles inward about forty-five degrees to a form a third chamfered edge 74C having a third face. The upper projection 70B is formed by the portion of the sidewall projecting laterally outboard between the second and third chamfered edges 74B, 74C. From the third chamfered edge 74C, the left edge continues upward until it meets the top edge 66 and forms the top left corner of the sidewall. The upper recess 72B is formed between the third chamfered edge 74C and the top left corner. The top edge portion is generally flat and is generally parallel to the bottom edge portion. For reasons explained below, through-holes 76 pass through the first, second, and third faces, of the respective first second, and third chamfered edges.

The right side portion includes a substantially similar but reverse configuration than the left side portion. The right edge portion includes an upper projection 80A, an upper recess 82A, a lower projection 80B, and a lower recess 82B, (broadly, “second set of connectors”). The upper projection 80A and the top edge 66 form a top right corner of the sidewall. Starting at the top right corner, the upper projection 80A extends in a generally downward direction until the right edge angles inward about forty-five degrees to form a fourth chamfered edge 86A having a fourth face. From the fourth chamfered edge 86A, the right edge continues in a downward direction until it angles outward at about forty-five degrees to form a fifth chamfered edge 86B having a fifth face. The fourth and fifth faces of the respective fourth and fifth chamfered edges generally face each other and further define the upper recess therebetween. From the fifth chamfered edge 86B, the right edge continues in a downward direction until in angles inward about forty-five degrees to a form a sixth chamfered edge 86C having a sixth face. The lower projection 80B is formed by the portion of the sidewall projecting laterally outboard between the fifth and sixth chamfered edges 86B, 86C. From the sixth chamfered edge 86C, the right edge continues downward until it meets the bottom edge and forms the bottom right corner of the sidewall. The lower recess is formed between the sixth chamfered edge and the bottom right corner. Through-holes 76 pass through the third, fourth, and fifth faces, of the respective third, fourth, and fifth chamfered edges.

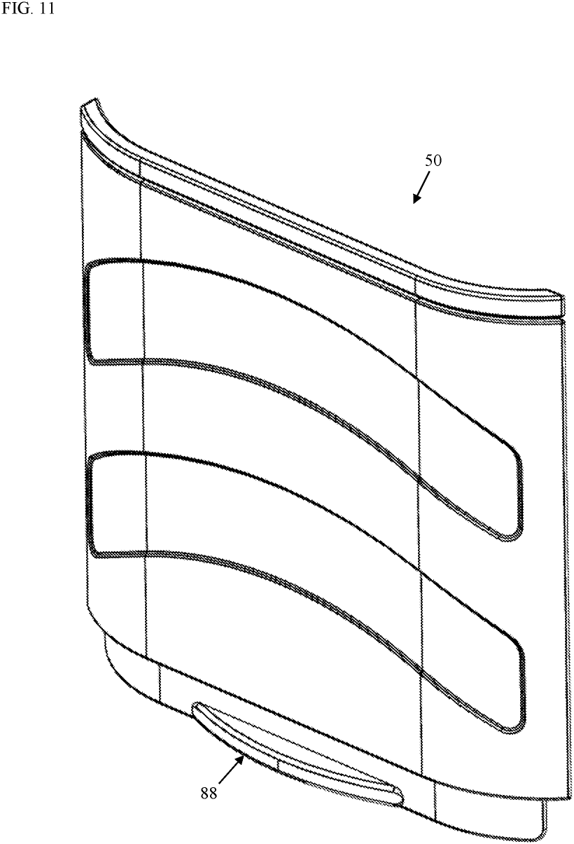

Referring to FIG. 11, the exterior side of the lower portion of the sidewall includes a rib 88 (broadly, “base connection structure” or “third connector”). The rib 88 is configured to engage with the recess of the base to limit movement of the sidewall.

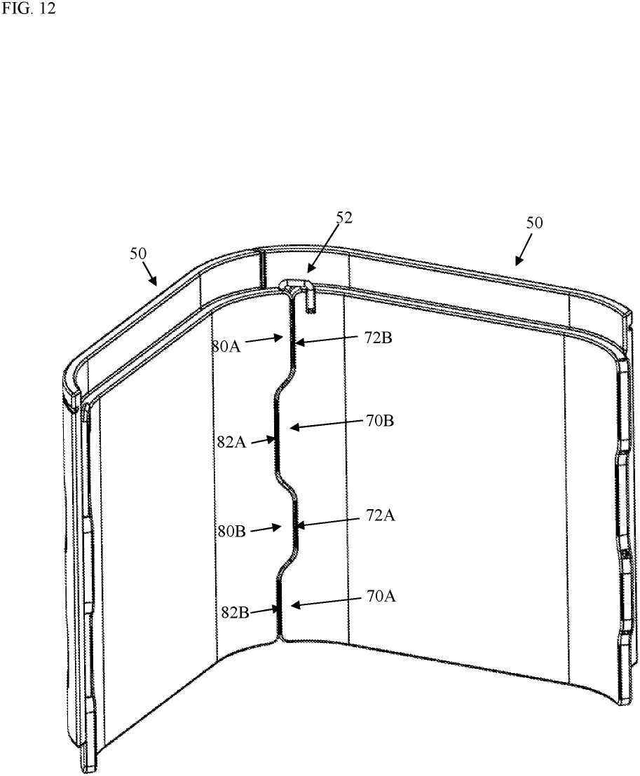

Referring to FIG. 12, the upper and lower projections of the right side of one sidewall are configured to mesh with corresponding upper and lower recesses of the left side of another sidewall (or vice-versa). When the projections and recesses of the respective sidewalls are meshed together, the through-holes are aligned to permit the connecting rod 52 to pass therethrough to from an interlocking connection. A groove is defined near the upper left corner of the left side portion and configured to hold a hook member of the connecting rod to limit the connecting rod 52 from inadvertently coming free. A cuff portion 51 extends from the left edge portion and the top edge portion and provides additional structural support and rigidity at the sidewall connection interface.

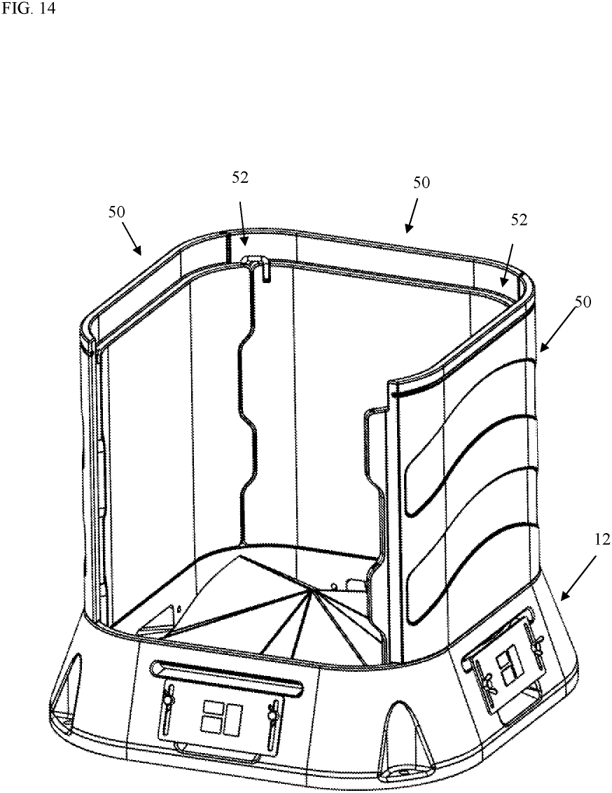

Referring to FIGS. 12-15, the first connectors of a first sidewall are meshed with the second connectors of a second sidewall so to align the through holes. The connecting rod is threaded through the aligned holes to form an interlocking connection. The user manipulates the two sidewalls as needed to arrange corresponding ribs 88 into corresponding recesses. In doing so, the bottom edge 68 of the sidewall engages the shoulder 20 and the exterior side of the bottom portion engages the collar. The user manipulates a third sidewall so the rib is received in the corresponding recess. The user manipulates the first set of connectors of the third sidewall with the second set of connectors of the second sidewall (FIG. 14). The user manipulates the remaining sidewall so that the rib is received in the corresponding recess and to form another interlocking connection. It is not outside the scope of this disclosure for one or all of the sidewalls to be integrally formed with the base tray holder. Other modular sidewall shapes (e.g. semi-circular, polygon, etc.) configured to form an interlocking connection are not outside the scope of this disclosure. Moreover, other types of hopper constructions (e.g., more or fewer hopper sidewalls, or hopper sidewalls having other configurations) can be used without departing form the scope of the present disclosure.

The user can selectively adjust the positions of each of the gates 46 as desired. For example, one gate can be entirely closed, one gate can be entirely open, and the other two gates can be partially opened, and any combination thereof. Initially, as the user dumps feed into the hopper through the inlet opening 34 some of the feed will expel from the feed channels if the gates are open. However, as the user continually dumps the feed into the hopper the granular feed will tend to plug the feed outlets and the hopper will begin filling with feed. As wildlife eat the feed from the feed outlets, the granular feed will shift around within the hopper. The combination of the force of gravity and the contours of the feed director will expel the feed out of the feed channel in an intermittent and controlled manner.

It will be apparent that modifications and variations are possible without departing from the scope of the invention defined in the appended claims. The dimensions and proportions described herein are by way of example without limitation. Other dimensions and proportions can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A wildlife gravity feeder assembly for dispensing a bulk feed material, the wildlife gravity feeder assembly comprising:
a hopper body defining an interior for holding the bulk feed material; and
a base assembly comprising:
a base defining at least one feed outlet; and
a feed director body formed separately from the base and supported by the base, the feed director body defining at least one funnel configured to direct bulk feed material to flow by gravity from the interior toward the at least one feed outlet.

2. The wildlife gravity feeder assembly as set forth in claim 1, wherein the funnel includes a flow channel that increases in width as the flow channel extends toward the respective feed outlet.

3. The wildlife gravity feeder assembly as set forth in claim 1, wherein the base defines a second feed outlet, and the feed director body defines a second funnel configured to direct bulk feed material to flow by gravity from the interior to the second feed outlet.

4. The wildlife gravity feeder assembly as set forth in claim 3, wherein the base defines a third feed outlet, and the feed director body defines a third funnel configured to direct bulk feed material to flow by gravity from the interior to the third feed outlet.

5. The wildlife gravity feeder assembly as set forth in claim 4, wherein the base defines a fourth feed outlet, and the feed director body defines a fourth funnel configured to direct bulk feed material to flow by gravity from the interior to the fourth feed outlet.

6. The wildlife gravity feeder assembly as set forth in claim 5, wherein the four funnels intersect at a peak, the peak being a highest point of the surface of the feed director body.

7. The wildlife gravity feeder assembly as set forth in claim 1, wherein the feed director body is configured to bound a bottom of the interior of the hopper.

8. The wildlife gravity feeder assembly as set forth in claim 1, wherein the feed outlet includes a bottom surface that slopes to an exit of the feed outlet, the exit of the feed outlet forming an exit of the gravity feeder assembly from which the bulk feed material exits the gravity feeder assembly.

9. The wildlife gravity feeder assembly as set forth in claim 1, wherein the hopper body is formed separately from the base assembly.

10. A wildlife gravity feeder assembly for dispensing bulk feed material, the wildlife gravity feeder assembly comprising:
a base; and
a hopper body configured to be connected to the base to define an interior for holding a supply of bulk feed material, the hopper body having at least two sidewall portions that are formed separately and connectable to each other for forming the hopper body.

11. The wildlife gravity feeder assembly as set forth in claim 10, wherein the at least two sidewall portions are configured to form a mating connection to connect the at least two sidewall portions.

12. The wildlife gravity feeder assembly as set forth in claim 10, wherein the at least two sidewall portions include a first sidewall portion and a second sidewall portion, the first sidewall portion having a first set of connectors and a second set of connectors, and the second sidewall portion having a first set of connectors and a second set of connectors, the first set of connectors of the first sidewall portion being configured to mesh with the second set of connectors of the second sidewall portion to form a mating connection.

13. The wildlife gravity feeder assembly as set forth in claim 12, wherein the first set of connectors of the first sidewall portion comprises projections and recesses, and the second set of connectors of the second sidewall portion comprises projections and recesses.

14. The wildlife gravity feeder assembly as set forth in claim 12, wherein through holes extend through the projections of the first and second sets of connectors, the through holes being sized and shaped for receiving a connecting rod for limiting disconnection of the mating connection.

15. The wildlife gravity feeder assembly as set forth in claim 12, wherein one of the first sidewall portion or the second sidewall portion includes a cuff configured to overlap the mating connection for bracing the mating connection.

16. The wildlife gravity feeder assembly as set forth in claim 12, wherein edge portions of the projections are chamfered to facilitate formation of the mating connection.

17. The wildlife gravity feeder assembly as set forth in claim 12, wherein the hopper body includes a third sidewall portion, the first, second and third sidewall portions each include g a top edge, a bottom edge, a first side edge, and an opposite second side edge, the first side edge of the first sidewall portion including the first set of connectors of the first sidewall portion, the second side edge of the second sidewall portion including the second set of connectors of the first sidewall portion, the first side edge of the second sidewall portion including the first set of connectors of the second sidewall portion, and the second side edge of the second sidewall portion including the second set of connectors of the second sidewall portion, the third sidewall portion including a first side edge including a first set of connectors of the third sidewall portion, and the third sidewall portion including a second side edge including a second set of connectors of the third sidewall portion.

18. The wildlife gravity feeder assembly as set forth in claim 17, the first set of connectors of the second sidewall are configured to mesh with the second set of connectors of the third sidewall to form a mating connection.

19. The wildlife gravity feeder assembly as set forth in claim 18, wherein the hopper body includes a fourth sidewall portion, the fourth sidewall portion including a top edge, a bottom edge, a first side edge including a first set of connectors, and a second side edge including a second set of connectors.

20. The wildlife gravity feeder assembly as set forth in claim 19, wherein the first set of connectors of the third sidewall are configured to mesh with the second set of connectors of the fourth sidewall to form a third mating connection, and the first set of connectors of the fourth sidewall are configured to mesh with the second set of connectors of the first sidewall to form a fourth mating connection.

21. The wildlife gravity feeder assembly as set forth in claim 10, wherein each sidewall portion includes at least one of a protrusion or an opening, and the base comprises a corresponding at least one protrusion or opening, the at least one protrusion or opening of each sidewall portion being configured to mate with the other of the respective protrusion or opening of the base to connect the sidewall portion to the base.

22. The wildlife gravity feeder assembly as set forth in claim 21, wherein the hopper includes a third sidewall portion wherein the third sidewall portion includes at least one of a protrusion or an opening, and the base comprises a corresponding at least one protrusion or opening, the at least one protrusion or opening of the third sidewall portion being configured to mate with the other of the protrusion or opening of the base to connect the third sidewall portion to the base.

23. The wildlife gravity feeder assembly as set forth in claim 22, wherein the hopper includes a fourth sidewall portion wherein the fourth sidewall portion includes at least one of a protrusion or an opening, and the base comprises a corresponding at least one protrusion or opening, the at least one protrusion or opening of the fourth sidewall portion being configured to mate with the other of the protrusion or opening of the base to connect the fourth sidewall portion to the base.

24. The wildlife gravity feeder assembly as set forth in claim 10, wherein the base comprises a shoulder configured to engage the sidewall portions when the hopper body is connected to the base.

25. The wildlife gravity feeder assembly as set forth in claim 10, wherein the base includes a holder and a flow director configured to be receivable in the holder.

26. A wildlife gravity feeder assembly for dispensing bulk feed material, the wildlife gravity feeder assembly comprising:
a base; and
a hopper body defining an interior for holding the bulk feed material, the hopper body being connectable to the base;
wherein the base is configured to form a bottom of the interior.

27. The wildlife gravity feeder assembly as set forth in claim 26, wherein the hopper body and the base are configured to form a mating connection to connect the hopper body and the base.

28. The wildlife gravity feeder assembly as set forth in claim 26, wherein the hopper includes at least one of a protrusion or an opening, and the base further comprises a corresponding at least one protrusion or opening, the at least one protrusion or opening of the hopper being configured to mate with the other of the protrusion or opening of the base to connect the hopper to the base.

29. The wildlife gravity feeder assembly as set forth in claim 28, wherein the protrusion is configured to engage the opening to limit the removal of the hopper body from the base.

30. The wildlife gravity feeder assembly as set forth in claim 28, wherein the hopper comprises separate hopper sidewall components connectable to each other for forming the hopper.

31. The wildlife gravity feeder assembly as set forth in claim 28, wherein the base comprises a shoulder configured to engage the hopper body when the hopper body is connected to the base.

32. The wildlife gravity feeder assembly as set forth in claim 28, wherein the base includes a collar and the hopper body is configured to fit inside the collar for connecting the hopper body to the base.

33. A wildlife gravity feeder assembly for dispensing bulk feed material, the wildlife gravity feeder assembly comprising:
a hopper body including an inlet opening and at least two feed openings located below the inlet opening; and
at least two funnels located in an interior space of the hopper body below the inlet opening, each funnel corresponding to a respective feed opening; each funnel including a feed channel including a slide surface extending downwardly toward the respective feed outlet, a width of each feed channel widening toward the respective feed opening.
